(19) United States
(12) Patent Application Publication
(10) Pub. No.: US 2024/0418634 A1
(43) Pub. Date: Dec. 19, 2024

(54) OPTICAL MEASUREMENT DEVICE

(71) Applicant: The University of Electro-Communications, Tokyo (JP)

(72) Inventors: Takashi KATO, Chofu-shi (JP); Kaoru MINOSHIMA, Chofu-shi (JP)

(73) Assignee: The University of Electro-Communications, Tokyo (JP)

(21) Appl. No.: 18/812,047

(22) Filed: Aug. 22, 2024

Related U.S. Application Data
(63) Continuation of application No. PCT/JP2023/006392, filed on Feb. 22, 2023.

(30) Foreign Application Priority Data
Feb. 24, 2022 (JP) 2022-026953

(51) Int. Cl. G01N 21/27

(52) U.S. Cl. CPC G01N 21/27

(57) ABSTRACT

An optical measurement device includes: a light source generating an optical frequency comb; a first optical path guiding an optical pulse train having a pulse interval based on the repetition frequency of the optical frequency comb and an inter-pulse phase difference based on a carrier envelope offset frequency and a repetition frequency to a measurement target; a second optical path guiding measurement result light acquired from the measurement target; a third optical path guiding delay light acquired by delaying the optical pulse train; an interference unit causing the measurement result light guided by the second optical path and the delay light guided by the third optical path to interfere with each other; and a control unit performing variable control of at least one of the carrier envelope offset frequency and the repetition frequency of the light source on the basis of the state of light.

### CROSS-REFERENCE TO RELATED APPLICATIONS

The present application is a continuation of International Application No. PCT/JP2023/006392 filed Feb. 22, 2023, and priority is claimed on Japanese Patent Application No. 2022-026953, filed Feb. 24, 2022, the contents of each are incorporated herein by reference.

### TECHNICAL FIELD

The present invention relates to an optical measurement device.

### BACKGROUND ART

An ultrashort pulse train being in a state in which optical frequency mode sequences in which spectrum intensities are aligned in c comb shape accurately at equal intervals on a frequency axis are synchronized in phase with each other, and absolute values thereof are completely controlled is referred to as an “optical frequency comb” or simply an “optical comb.” For example, on the frequency axis of a mode synchronization laser that is an ultrashort pulse laser, multiple optical frequency mode sequences aligned at equal intervals appear, and the optical frequency modes are synchronized in phase with each other. When this optical frequency is completely controlled, this light source becomes an optical comb. An optical frequency can be controlled using an extremely accurate clock such as an atomic clock and thus is widely used as an accurate optical frequency/distance (for example, see Non-Patent Document 1).

### CITATION LIST

### Non-Patent Document

### [Non-Patent Document 1]

Steven T. Cundiff and Jun Ye “Colloquium: Femtosecond optical frequency combs,” REVIEWS OF MODERN PHYSICS, VOLUME 75, JANUARY (2003).

### SUMMARY OF INVENTION

### Technical Problem

As disclosed in Non-Patent Document 1 described above, the optical frequency comb has been used as a light source stabilized with high accuracy. In other words, the optical frequency comb can be regarded as a low-jitter coherent pulse train in the time domain and a precisely mode-resolved comb-shaped spectrum in the frequency domain. Conventionally, a carrier-envelope offset frequency and a repetition frequency (frequency interval) of such an optical frequency comb and a carrier-envelope offset frequency difference and a repetition frequency difference at the time of using two optical frequency combs have been treated as fixed parameters.

Incidentally, optical measurement is widely used in fields of distance measurement, shape measurement, spectroscopy, and the like. As a basic measurement method in such optical measurement, measurement light is emitted to a measurement target object, and transmitted light and reflected light thereof are measured. However, in such optical measurement, in accordance with multiple reflections of measurement light on a measurement target object, extraneous light (background light) other than light that is originally desired to be measured may be generated. For example, problems such as surface reflection light stronger than internal reflection light being generated on the surface of a measurement target object in a case in which internal reflection of the measurement target object is desired to be measured and transmissive light stronger than a nonlinear light signal being observed in a case in which a weak nonlinear signal is desired to be observed, and the like may occur. When such strong background light is present, light that is originally desired to be measured may be buried therein.

Conventionally, in order to eliminate strong background light, division of light in time using a delay time difference between light that is originally desired to be measured and background light and spatial separation using a deviation between optical axes of light that is originally desired to be measured and background light have been performed. However, in a case in which there is hardly a deviation in delay time difference or a deviation in optical axes between light that is originally desired to be measured and background light, there is a problem that the background light cannot be effectively eliminated using a time/space separation means.

The present invention is in consideration of the situations described above and provides an optical measurement device capable of eliminating background light in optical measurement using high controllability according to an optical frequency comb.

### Solution to Problem

One embodiment of the present invention is an optical measurement device including: a light source generating an optical frequency comb having a predetermined carrier envelope offset frequency with respect to zero of a frequency axis and a plurality of frequency modes aligned at intervals of integer multiples of a predetermined repetition frequency with reference to the carrier envelope offset frequency on the frequency axis; a first optical path guiding an optical pulse train having a pulse interval based on the repetition frequency of the optical frequency comb generated by the light source and an inter-pulse phase difference based on the carrier envelope offset frequency and the repetition frequency to a measurement target; a second optical path guiding measurement result light acquired from the measurement target to which the optical pulse train guided by the first optical path has been emitted; a third optical path guiding delay light acquired by delaying the optical pulse train by a delay time corresponding to the pulse interval; an interference unit causing the measurement result light guided by the second optical path and the delay light guided by the third optical path to interfere with each other; and a control unit performing variable control of at least one of the carrier envelope offset frequency and the repetition frequency of the light source on the basis of the state of light after interference by the interference unit.

In addition, according to one embodiment of the present invention, the optical measurement device described above further includes an acquisition unit acquiring at least one of an amplitude and a frequency of the light after the interference as the state of the light, in which the control unit performs variable control of at least one of the carrier envelope offset frequency and the repetition frequency of the light source on the basis of an acquisition result of the state of the light acquired by the acquisition unit and information representing a reference of the state of the light.

In addition, according to one embodiment of the present invention, in the optical measurement device described above, the control unit changes the pulse interval and the inter-pulse phase difference of the optical pulse train by performing sweep variable control of at least one of the carrier envelope offset frequency and the repetition frequency of the light source.

In addition, according to one embodiment of the present invention, in the optical measurement device described above, the control unit changes the pulse interval of the optical pulse train by changing the repetition frequency without changing a ratio between the carrier envelope offset frequency and the repetition frequency.

In addition, according to one embodiment of the present invention, in the optical measurement device described above, the control unit changes the inter-pulse phase difference of the optical pulse train by changing a ratio between the carrier envelope offset frequency and the repetition frequency.

In addition, according to one embodiment of the present invention, in the optical measurement device described above, a measuring unit measuring light after interference by the interference unit as signal light is further included.

In addition, according to one embodiment of the present invention, in the optical measurement device described above, a second interference unit causing reference light of the optical pulse train based on the optical pulse train and the measurement result light or light after interference by the interference unit to interfere with each other; and a second measuring unit measuring light interfered with by the second interference unit as signal light is further included.

### Advantageous Effects of Invention

According to the present invention, background light can be selectively eliminated in optical measurement using an optical frequency comb.

### BRIEF DESCRIPTION OF DRAWINGS

FIG. 1A is a diagram illustrating a correspondence relation between a waveform of a time domain and a spectrum distribution of a frequency domain for an optical frequency comb.

FIG. 1B is a diagram illustrating one example of an ultrashort pulse.

FIG. 2 is a diagram illustrating one example of the configuration of an optical measurement device 1 according to this embodiment.

FIG. 3 is a diagram illustrating a first modified example of the configuration of a delay unit according to this embodiment.

FIG. 4 is a diagram illustrating a second modified example of the configuration of the delay unit according to this embodiment.

FIG. 5 is a diagram illustrating one example of the configuration of an optical measurement device 2 according to a modified example of this embodiment.

FIG. 6 is a diagram illustrating one example of a measurement result acquired by the optical measurement device 2 according to the modified example of this embodiment.

### DESCRIPTION OF EMBODIMENTS

Hereinafter, an embodiment of an optical measurement device according to the present invention will be described with reference to the drawings. The drawings used in the following description are schematic, and ratios and the like of lengths, widths, and thicknesses may not be the same as actual ratios and the like and may be changed appropriately.

### [Optical Frequency Comb]

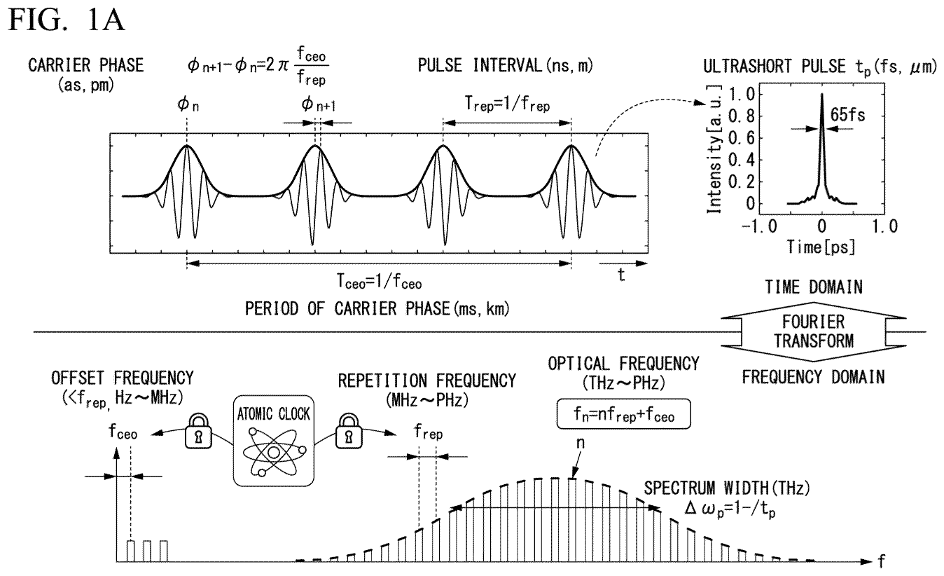

FIG. 1A is a diagram illustrating a correspondence relation between a waveform of a time domain and a spectrum distribution of a frequency domain for an optical frequency comb.

When seen from the time domain, an output from a mode synchronization laser is a periodic pulse train and can be illustrated using a function of electric field vibrating at a high speed and envelope.

Generally, an optical comb having an optical frequency mode group aligned at equal intervals on a frequency axis can be completely expressed using two frequencies called a repetition frequency (frep) and a carrier envelope frequency (fceo). The repetition frequency represents an interval of each optical frequency mode and represents an inter-pulse distance of an ultrashort pulse train on the time axis. FIG. 1B illustrates one example of an ultrashort pulse. On the other hand, the carrier envelope frequency is represented as a deviation (an offset) occurring in a case in which an optical frequency mode sequence is repeatedly extended to a DC on the frequency axis. When this is considered on the time axis, it represents a carrier phase difference between pulses of the pulse train. Here, a carrier phase is referred to as a so-called carrier envelope offset phase (CEP) (in the following description, it may also be referred to as a carrier phase). Each carrier phase (on) of a pulse train on the time axis changes by a constant phase amount for every pulse and, consequently, has a constant period (the period Tceo of the carrier phase). A relative carrier phase difference between pulse trains adjacent to each other on the time axis is also called an inter-pulse phase difference.

As represented in Equation (1), a reciprocal of the period Tceo of the carrier phase is a carrier envelope offset frequency fceo on the frequency axis.

$$Tceo = 1 / fceo \qquad ( 1 )$$

In addition, as represented in Equation (2), a reciprocal of the repetition period Trep of a pulse (pulse interval) is a repetition frequency (frequency interval) frep.

$$Trep = 1 / frep \qquad ( 2 )$$

When an output of the mode synchronization laser is observed on the frequency axis, a vertical mode (an optical frequency mode) of the laser is distributed extremely uniformly at a repetition frequency (frequency interval) frep interval.

The carrier envelope offset frequency fceo and the repetition frequency frep have a relation as represented in Equation (3) using an inter-pulse phase difference (φ(n+1)−φn).

$$φ ( n + 1 ) - φ n = 2 π ( fceo / frep ) \qquad ( 3 )$$

As described above, the repetition frequency frep and the carrier envelope offset frequency fceo of an optical frequency comb are important frequency parameters representing characteristics of a pulse train. In this embodiment, a degree of freedom of control of the repetition frequency frep and the carrier envelope offset frequency fceo is actively utilized.

### [Configuration of Optical Measurement Device 1]

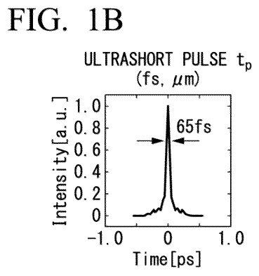

FIG. 2 is a diagram illustrating one example of the configuration of the optical measurement device 1 according to this embodiment. The optical measurement device 1 includes a light source 10, a measurement unit 20, a measuring unit 30, and an acquisition unit 40.

The light source 10, for example, is a mode synchronization laser light source and generates an optical frequency comb. This optical frequency comb has a predetermined carrier envelope offset frequency fceo with respect to zero of the frequency axis and a plurality of frequency modes aligned at intervals of integer multiples of a predetermined repetition frequency frep with reference to the carrier envelope offset frequency fceo on the frequency axis.

The light source 10 outputs an optical pulse train L1 according to the generated optical frequency comb to the measurement unit 20. The optical pulse train L1 has a pulse interval Trep based on the repetition frequency frep of the optical frequency comb generated by the light source 10 and an inter-pulse phase difference (φ(n+1)−φn) based on the carrier envelope offset frequency fceo and the repetition frequency frep.

The measurement unit 20 has a first optical path 21, a second optical path 22, a third optical path 23, and an interference unit 24.

The first optical path 21 guides the optical pulse train L1 to a measurement target 25.

The second optical path 22 guides measurement result light L2 acquired from the measurement target 25 to which the optical pulse train L1 guided by the first optical path 21 has been emitted.

The third optical path 23 guides delay light L3 acquired by delaying the optical pulse train L1 by a delay time corresponding to the pulse interval Trep.

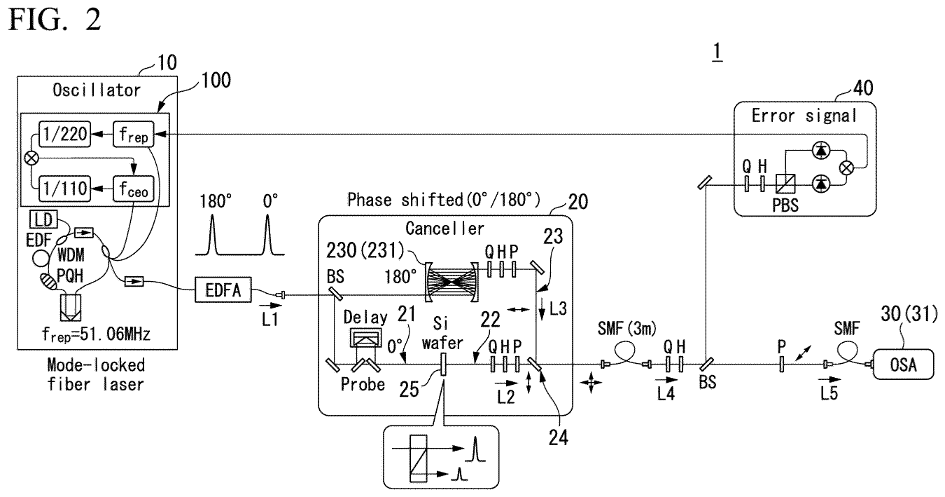

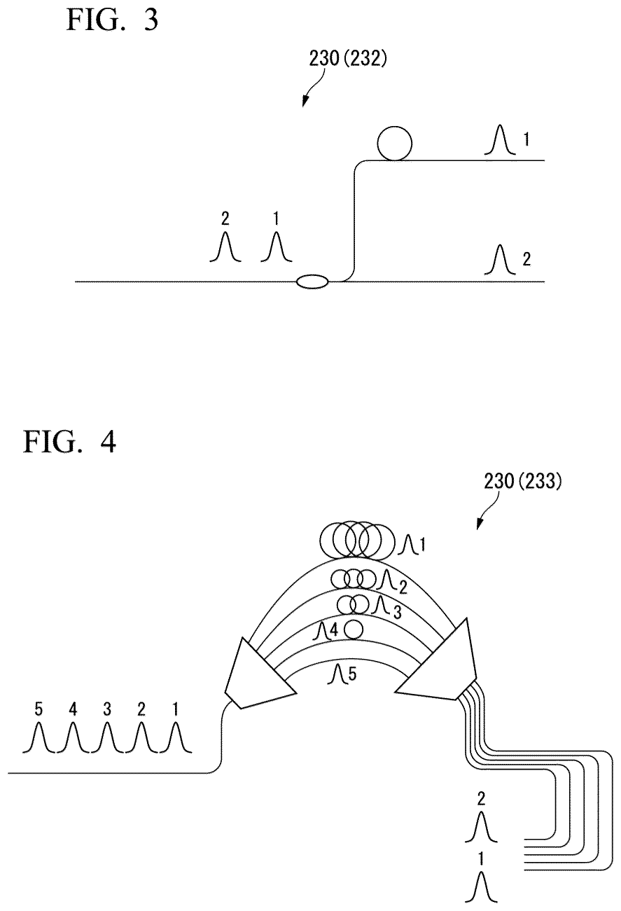

More specifically, the measurement unit 20 includes a delay unit 230 in the third optical path 23. In one example of this embodiment, the delay unit 230 includes an optical delay circuit using a space optical system such as a multi-pass cavity (MPC) or the like. In addition, the delay unit 230 may have any configuration, for example, as illustrated in FIG. 3 or FIG. 4 as long as it can adjust frequency dependency (dispersion) of the delay.

FIG. 3 is a diagram illustrating a first modified example of the configuration of the delay unit according to this embodiment. The delay unit 232 of the first modified example includes an optical delay circuit using optical fibers.

FIG. 4 is a diagram illustrating a second modified example of the configuration of the delay unit according to this embodiment. A delay unit 233 of the second modified example includes an optical delay circuit using a waveguide (for example, arrayed waveguide gratings (AWG)).

Referring back to FIG. 2, the interference unit 24 causes the measurement result light L2 guided by the second optical path 22 and the delay light L3 guided by the third optical path 23 to interfere with each other.

The measuring unit 30 measures light L4 after interference by the interference unit 24 as signal light L5. Here, although the signal light L5 is guided to an OSA by an SMF, and a spectrum is measured, other optical system and measurement device may be used in accordance with a measurement target.

The acquisition unit 40 acquires at least one of an amplitude and a frequency of the light L4 after interference as the state of light.

The light source 10 includes a control unit 100. The control unit 100 performs variable control of at least one of the carrier envelope offset frequency fceo and the repetition frequency frep of the light source 10 on the basis of the state of the light L4 after interference by the interference unit 24.

Here, by changing a ratio between two radio frequency parameters (the repetition frequency frep and the carrier envelope offset frequency fceo) controlling the optical pulse train L1, all the phases of the band of the light source 10 can be uniformly controlled. In addition, as represented in Equation (3) described above, by changing the ratio between the repetition frequency frep and the carrier envelope offset frequency fceo, a phase difference of pulses, which are adjacent to each other, of the optical pulse train L1, that is, an inter-pulse phase difference (φ(n+1)−φn) is controlled.

Thus, by dividing the optical pulse train L1 into two optical paths including a first optical path 21 and a third optical path 23 and applying a delay to pulse light of one of the optical paths (that is, the third optical path 23), a desired phase difference pulse pair can be generated between pulse light of the first optical path 21 (that is, measurement result light L2) and pulse light of the third optical path 23 (that is, delay light L3). By applying the inter-pulse phase difference (φ(n+1)−φn) corresponding to a delay time of the third optical path 23 to the optical pulse train L1 such that the measurement result light L2 of the first optical path 21 and the delay light L3 of the third optical path 23 have opposite phases and causing the measurement result light L2 and the delay light L3 to interfere with each other, background light included in the measurement result light L2 can be eliminated. In other words, by controlling the inter-pulse phase difference (φ(n+1)−φn) of the optical pulse train L1 by changing the ratio between the repetition frequency frep and the carrier envelope offset frequency fceo, background light of the measurement result light L2 can be eliminated.

In addition, the control unit 100 may perform feedback control of at least one of the carrier envelope offset frequency fceo and the repetition frequency frep on the basis of the state of the light L4 after interference. At this time, a mutual frequency ratio may be configured to be constant, and an absolute frequency here may be fixed.

In performing control, by using a circuit using a divider, a mixer, and the like as illustrated in the control unit 100, a frequency ratio between the repetition frequency and the carrier envelope offset frequency may be set as a predetermined frequency ratio. In addition, frequency measurement may be performed using a microprocessor such as an FPGA and the like.

In other words, the control unit 100 performs variable control of at least one of the carrier envelope offset frequency fceo and the repetition frequency frep of the light source 10 on the basis of an acquisition result of the state of light acquired by the acquisition unit 40 and information representing a reference of the state of light.

In addition, in this embodiment, although a case in which light transmitting through the measurement target 25 is light that is a measurement target for the measuring unit 30 will be described as one example, the configuration is not limited thereto. Light reflected from the measurement target 25 may be set as light that is a measurement target for the measuring unit 30. In other words, the optical measurement device 1 according to this embodiment may be a transmissive-type measurement device measuring transmissive light or a reflective-type measurement device measuring reflection light.

### [One Example of Control Using Control Unit 100]

Here, one example of control using the control unit 100 will be described. For example, in a case in which background light according to internal reflection of the measurement target 25 is desired to be eliminated, dispersion according to the measurement target 25 is given to the background light. For this reason, there are cases in which the background light cannot be sufficiently eliminated only by causing the delay light L3 to simply interfere with the light L4 after interference.

### (1) Sweep Control of Carrier Envelope Offset Frequency Fceo or Repetition Frequency Frep

Thus, the control unit 100 according to this embodiment performs sweep variable control of the state of the delay light L3 caused to interfere with the light L4 after interference.

By performing sweep variable control of at least one of the carrier envelope offset frequency fceo and the repetition frequency frep of the light source 10, the control unit 100 changes the pulse interval Trep of the optical pulse train L1 and the inter-pulse phase difference (φ(n+1)−φn).

According to the control unit 100 configured in this way, background light having a dispersion effect of the measurement target 25 can be eliminated. Here, in the sweep variation control of the state of the delay light L3, only the parameters (the carrier envelope offset frequency fceo and the repetition frequency frep) of the optical pulse train L1 need to be variably controlled, and variable control using a mechanical component is not necessary. Thus, according to the control unit 100 configured in this way, background light having a dispersion effect of the measurement target 25 can be eliminated while an occurrence of control error due to the mass and the accuracy of a mechanical component is suppressed.

### (2) Sweep Control of Pulse Interval Trep

By changing the repetition frequency frep without changing the ratio between the carrier envelope offset frequency fceo and the repetition frequency frep, the control unit 100 changes the pulse interval Trep of the optical pulse train L1.

For example, the control unit 100 performs variable control of the repetition frequency frep for a state change of the light L4 after interference due to environmental variations, thereby performing feedback control of canceling effects caused by the environmental variations. According to the control unit 100 configured in this way, a state change of the light L4 after interference due to environmental variations is reduced, and smaller signal light L5 can be caused to stand out more. In other words, according to the control unit 100 configured in this way, the optical measurement device 1 having higher robustness for change environmental variations can be realized.

(3) Sweep Control of Inter-pulse Phase Difference (φ(n+1)−φn)

By changing the ratio between the carrier envelope offset frequency fceo and the repetition frequency frep, the control unit 100 changes the inter-pulse phase difference (φ(n+1)−φn) of the optical pulse train L1.

For example, by performing variable control of the repetition frequency frep for a state change of the light L4 after interference due to environmental variations, the control unit 100 changes the ratio between the carrier envelope offset frequency fceo and the repetition frequency frep while performing feedback control of canceling effects according to environmental variations. According to the control unit 100 configured in this way, sweep variable control of the inter-pulse phase difference (φ(n+1)−φn) of the optical pulse train L1 can be performed while reducing a state change of the light L4 after interference due to environmental variations.

### [Modified Example of Configuration of Optical Measurement Device]

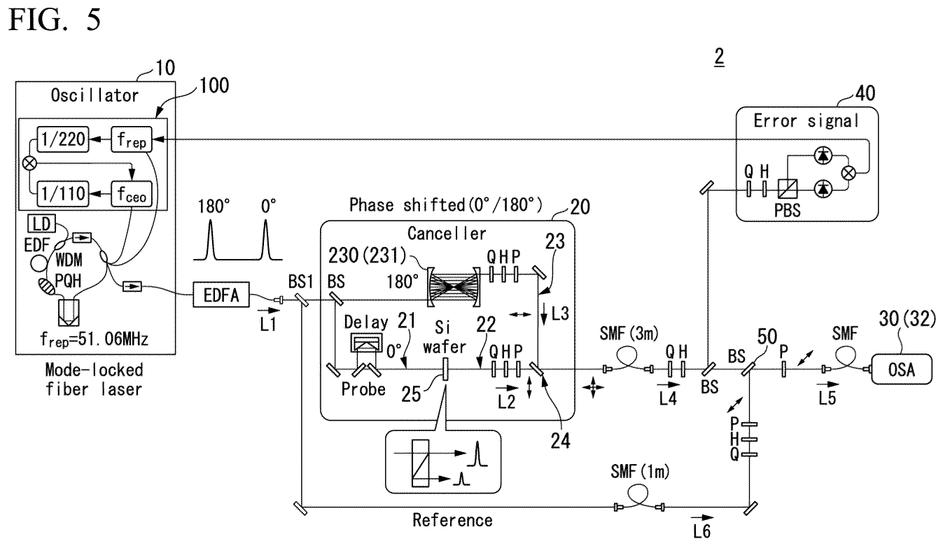

FIG. 5 is a diagram illustrating one example of the configuration of an optical measurement device 2 according to a modified example of this embodiment.

Although the optical measurement device 1 described above, for example, has been described to perform weak signal detection (non-interferometric measurement) such as optical sensing, optical space communication, cryptographic communication, radio astronomy observations, and the like as one example, the configuration is not limited thereto.

The optical measurement device may perform interference measurement using reference light. The optical measurement device 2 according to this modified example is different from the optical measurement device 1 described above in that the optical measurement device 2 includes a second interference unit 50 and a second measuring unit 32.

As one example of interferometric measurement, applications to an optical coherence tomography (OCT), a Raman spectroscopy device, a thin film measurement device, and the like can be performed.

The second interference unit 50 causes reference light L6 generated by dividing the optical pulse train L1 using a beam splitter BS1 and light L4 after interference by the interference unit 24 to interfere with each other.

The second measuring unit 32 measures light interfered by the second interference unit 50 as signal light L5.

In addition, in this modified example, although the second interference unit 50 has been described to have a configuration causing the reference light L6 and the light L4 after interference to interfere with each other, the configuration is not limited thereto. The second interference unit 50 may cause the reference light L6 and light before interference by the interference unit 24 (that is, measurement result light L2) to interfere with each other. In this case, the interference unit 24 causes light after interference according to the second interference unit 50 and the delay light L3 to interfere with each other.

In addition, in this modified example, although a case in which the reference light L6 is light generated by dividing the optical pulse train L1 using the beam splitter BS1 will be described as one example, the configuration is not limited thereto. The reference light L6 may not necessarily be light output by the light source 10. For example, light output by a second light source other than the light source 10 may be set as the reference light L6. In this case, light emitted from the second light source may be an optical pulse train having coherence with an optical pulse train output by the light source 10. In other words, the reference light L6 may be an optical pulse train based on the optical pulse train L1.

In other words, the second interference unit 50 causes the reference light L6 of the optical pulse train based on the optical pulse train L1 and the measurement result light L2 or the light L4 after interference by the interference unit 24 to interfere with each other.

### [One Example of Measurement Result]

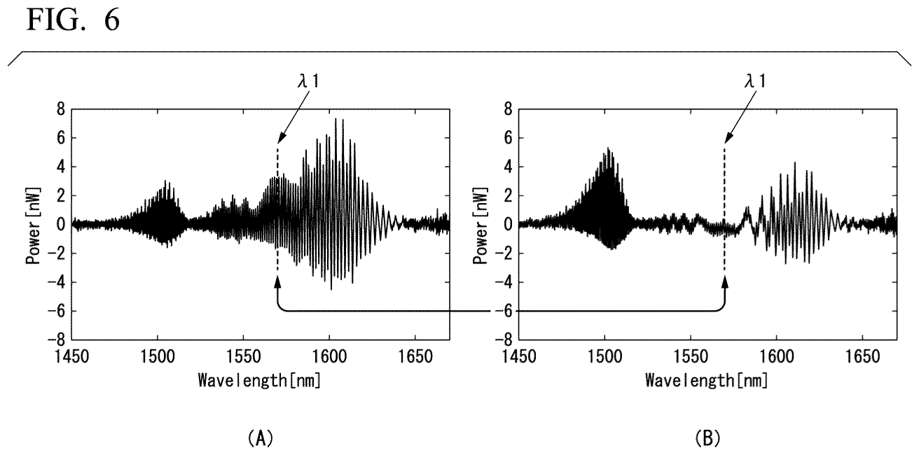

FIG. 6 is a diagram illustrating one example of a measurement result acquired by the optical measurement device 2 according to the modified example of this embodiment. Here, Si-based transmissive light and internal reflection light are set as a measurement target, strong transmissive light is background light, and weak internal reflection is a measurement target. FIG. 6[A] illustrates one example of a measurement result of signal light L5 of a case in which background light elimination, so-called noise cancellation is not performed in a case in which the measurement result light L2 and the delay light L3 are not caused to interfere with each other by the interference unit 24. A signal represented here is a spectrum interference fringe of the signal light L5. FIG. 6[B] illustrates one example of a measurement result of signal light L5 of a case in which the measurement result light L2 and the delay light L3 are caused to interfere with each other by the interference unit 24, in other words, a case in which noise cancellation is performed.

In one example of this measurement result, the horizontal axis represents a wavelength of the signal light L5, and the vertical axis represents the intensity of the signal light L5. Here, two spectrum interference fringes overlap each other and are a spectrum interference fringe of high-intensity background light and the reference light L6 and a spectrum interference fringe of weak signal light and the reference light L6. A wavelength λ1 is a minimum interference fringe frequency wavelength of a spectrum interference fringe that is an observation target of the signal light L5. Here, the minimum interference fringe frequency wavelength represents a wavelength component in which chirped reference light L6 and signal light completely overlap each other on the time axis.

In a case in which the noise cancellation illustrated in FIG. 6[A] is not performed, in a broadband having a wavelength λ1 as its center, a spectrum interference fringe of background light and the reference light L6 strongly appears under the influence of the background light (that is, a noise component).

In a case in which the noise cancellation illustrated in FIG. 6[B] is performed, the influence of the background light (that is, a noise component) at the wavelength λ1 is reduced, and the intensity of the spectrum interference fringe of the background light and L6 is weakened. As a result, in the case illustrated in FIG. 6[B], compared to the case illustrated in FIG. 6[A], the spectrum interference fringe of weak internal reflection light included in the signal light L5 and L6 is further manifested.

### SUMMARY OF EMBODIMENT

As described above, the optical measurement devices according to this embodiment and the modified example applies the inter-pulse phase difference (φ(n+1)−φn) corresponding to a delay time of the third optical path 23 to the optical pulse train L1 such that the measurement result light L2 of the first optical path 21 and the delay light L3 of the third optical path 23 have opposite phases and causes the measurement result light L2 and the delay light L3 to interfere with each other, thereby eliminating background light included in the measurement result light L2.

According to the optical measurement device configured in this way, by controlling the inter-pulse phase difference (φ(n+1)−φn) of the optical pulse train L1 by changing the ratio between the repetition frequency frep and the carrier envelope offset frequency fceo, noise cancellation of the measurement result light L2 can be performed.

In addition, although the inter-pulse phase difference of the optical pulse train L1 has been described as being a phase difference between pulses adjacent to each other, the configuration is not limited thereto. The inter-pulse phase difference of the optical pulse train L1 only needs to be an inter-pulse phase difference corresponding to a delay time of the third optical path 23, and the ratio between the repetition frequency frep and the carrier envelope offset frequency fceo may be controlled using a phase difference between every other pulses or a phase difference between every two pulses as the inter-pulse phase difference of the optical pulse train L1.

As above, although the embodiment of the present invention has been described in detail with reference to the drawings, a specific configuration is not limited to this embodiment, and a change can be made appropriately in a range not departing from the concept of the present invention. The configurations described in the embodiments described above may be combined together.

In addition, each unit included in each device according to the embodiment described above may be realized by dedicated hardware or may be realized by a memory and a microprocessor.

Furthermore, each unit included in each device may be configured by a memory and a central processing unit (CPU), and the function thereof may be realized by loading a program used for realizing the function of each unit included in each device into a memory and executing the program.

In addition, a program used for realizing the function of each unit included in each device may be recorded on a computer-readable recording medium, and a process using each unit included in a control unit may be performed by causing a computer system to read the program recorded on this recording medium and execute the program. A “computer system” described here includes an OS and hardware such as peripherals and the like.

In addition, the “computer system” also includes a home page providing environment (or a display environment) in a case in which a WWW system is used.

A “computer-readable recording medium” represents a storage device including a portable medium such as a flexible disk, a magneto-optical disc, a ROM, or a CD-ROM, a hard disk built in a computer system, and the like. Furthermore, a “computer-readable recording medium” also includes a medium dynamically storing the program for a short time such as a communication line in a case in which the program is transmitted through a network such as the Internet or a communication circuit line such as a telephone circuit line and a medium storing the program for a fixed time such as a volatile memory inside a computer system serving as a server or a client in such a case. In addition, the program described above may be used for realizing a part of the functions described above and, furthermore, may be a program realizing the functions described above by being combined with a program recorded in the computer system in advance.

### REFERENCE SIGNS LIST

1 Optical measurement device
10 Light source
20 Measurement unit
21 First optical path
22 Second optical path
23 Third optical path
24 Interference unit
30 Measuring unit
40 Acquisition unit

What is claimed is:

1. An optical measurement device comprising:
a light source generating an optical frequency comb having a predetermined carrier envelope offset frequency with respect to zero of a frequency axis and a plurality of frequency modes aligned at intervals of integer multiples of a predetermined repetition frequency with reference to the carrier envelope offset frequency on the frequency axis;
a first optical path guiding an optical pulse train having a pulse interval based on the repetition frequency of the optical frequency comb generated by the light source and an inter-pulse phase difference based on the carrier envelope offset frequency and the repetition frequency to a measurement target;
a second optical path guiding measurement result light acquired from the measurement target to which the optical pulse train guided by the first optical path has been emitted;
a third optical path guiding delay light acquired by delaying the optical pulse train by a delay time corresponding to the pulse interval;
an interference unit causing the measurement result light guided by the second optical path and the delay light guided by the third optical path to interfere with each other; and
a control unit performing variable control of at least one of the carrier envelope offset frequency and the repetition frequency of the light source on the basis of a state of light after interference by the interference unit.

2. The optical measurement device according to claim 1, further comprising an acquisition unit acquiring at least one of an amplitude and a frequency of the light after the interference as the state of the light,
wherein the control unit performs variable control of at least one of the carrier envelope offset frequency and the repetition frequency of the light source on the basis of an acquisition result of the state of the light acquired by the acquisition unit and information representing a reference of the state of the light.

3. The optical measurement device according to claim 1,
wherein the control unit changes the pulse interval and the inter-pulse phase difference of the optical pulse train by performing sweep variable control of at least one of the carrier envelope offset frequency and the repetition frequency of the light source.

4. The optical measurement device according to claim 1, wherein the control unit changes the pulse interval of the optical pulse train by changing the repetition frequency without changing a ratio between the carrier envelope offset frequency and the repetition frequency.

5. The optical measurement device according to claim 1, wherein the control unit changes the inter-pulse phase difference of the optical pulse train by changing a ratio between the carrier envelope offset frequency and the repetition frequency.

6. The optical measurement device according to claim 1, further comprising a measuring unit measuring light after interference by the interference unit as signal light.

7. The optical measurement device according to claim 1, further comprising:
a second interference unit causing reference light of the optical pulse train based on the optical pulse train and the measurement result light or light after interference by the interference unit to interfere with each other, and
a second measuring unit measuring light interfered with by the second interference unit as signal light.
